(19) United States
(12) Patent Application Publication
(10) Pub. No.: US 2012/0070677 A1
(43) Pub. Date: Mar. 22, 2012

(54) Flexible Metal-Clad Laminate and Manufacturing Method Thereof

(75) Inventors: Hong You, Daejeon (KR); Cholho Kim, Daejeon (KR); Weonjung Choi, Daejeon (KR); Daenyoun Kim, Daejeon (KR)

(73) Assignee: SK INNOVATION CO., LTD., Seoul (KR)

(21) Appl. No.: 13/321,938

(22) PCT Filed: May 24, 2010
(86) PCT No.: PCT/KR2010/003246

§ 371 Date: Nov. 22, 2011

(30) Foreign Application Priority Data
May 25, 2009 (KR) 10-2009-0045654

(51) Int. Cl. B32B 15/08; C08J 7/04

(52) U.S. Cl. 428/458; 427/520

(57) ABSTRACT

Provided are a flexible metal clad laminate and a method for manufacturing the same. The flexible metal clad laminate is obtained by applying a polyimide precursor resin convertible into a polyimide resin many times onto a metal clad, followed by drying, and by converting the polyimide precursor resin into a polyimide resin through infrared ray (IR) heat treatment. The polyimide resin layer that is in direct contact with the metal clad has a glass transition temperature of 300° C. or higher, and the polyimide resin layer has an overall linear thermal expansion coefficient of 20 ppm/K or lower. It is possible to obtain a flexible metal clad laminate for flexible printed circuit boards that causes no curling before and after etching, shows a small change in dimension caused by heat treatment, and has high adhesion to a metal clad and excellent appearance after completing imidization.

### TECHNICAL FIELD

The present invention relates to a flexible metal clad laminate, and more particularly, to a flexible metal clad laminate that causes no curling before and after etching, shows a small change in dimension caused by heat treatment, has excellent appearance after completing imidization, and is industrially useful, as well as to a method for manufacturing the same.

### BACKGROUND ART

A flexible metal clad laminate is a laminate of a conductive metal foil with a dielectric resin, is amenable to microcircuit processing and allows bending in a narrow space. Thus, it has been used increasingly in a wide spectrum of applications, as current electronic appliances have been downsized in dimension and weight. Flexible metal clad laminates are classified into bi-layer types and tri-layer types. The tri-layer type flexible metal clad laminates using an adhesive show lower heat resistance and flame resistance and cause a larger dimensional change during heat treatment, as compared to the bi-layer type flexible metal clad laminates. For this reason, recently, the bi-layer type flexible metal clad laminates have been used more generally in fabricating flexible circuit boards as compared to the tri-layer type flexible metal clad laminates.

As recent electronic appliances have been fabricated to have high performance and high compactness, dimensional stability thereof during heat treatment has become important more and more. Particularly, when carrying out a reflow operation, in which a polyimide film having circuit pattering is dipped into a lead bath heated to high temperature, a dimensional change caused by the exposure to high temperature may occur frequently, resulting in mislocation between the circuit pattern of an electronic part and that of a metal clad laminate. Moreover, since lead-free soldering has been introduced more recently, it has been increasingly in demand to consider a dimensional change at high temperature.

### DISCLOSURE

### Technical Problem

An object of the present invention is to provide a flexible metal clad laminate for flexible printed circuit boards that causes no curling before and after etching, shows a small change in dimension caused by heat treatment, and has high adhesion to a metal clad and excellent appearance after completing imidization, as well as to a method for manufacturing the same.

### Technical Solution

In one general aspect, a flexible metal clad laminate includes: a metal clad; and a polyimide resin layer formed by applying a polyimide precursor resin convertible into a polyimide resin many times onto the metal clad, followed by drying, and by further drying and curing the polyimide precursor resin with an infrared ray (IR) heating system.

In another general aspect, a method for manufacturing a flexible metal clad laminate includes: applying a polyimide precursor resin convertible into a polyimide resin many times onto the metal clad, followed by drying; and further drying and curing the polyimide precursor resin with an IR heating system.

### Advantageous Effects

The flexible metal clad laminate according to an embodiment of the present invention causes no curling before and after etching, shows a small change in dimension caused by heat treatment, and has excellent appearance after completing imidization.

In addition, the flexible metal clad laminate may be applied to a flexible printed circuit board.

### DESCRIPTION OF DRAWINGS

The above and other objects, features and advantages of the present invention will become apparent from the following description of preferred embodiments given in conjunction with the accompanying drawings, in which:

FIG. 1 is a graph showing the results of infrared ray (IR) absorption spectrometry of the polyimide resin according to the present invention.

FIG. 2 is a photographic view showing the surface appearance of the flexible metal clad laminate according to Comparative Example 3.

### BEST MODE

Hereinafter, the embodiments of the present invention will be described in detail with reference to accompanying drawings. For the purposes of clarity and simplicity, a detailed description of known functions and configurations incorporated herein will be omitted as it may make the subject matter of the present invention unclear.

As used herein, the terms “about”, “substantially”, or any other version thereof, are defined as being close to the value as mentioned, when a unique manufacturing and material tolerance is specified. Such terms are used to prevent any unscrupulous invader from unduly using the disclosure of the present invention including an accurate or absolute value described to assist the understanding of the present invention.

The present invention provides a flexible metal clad laminate including: a metal clad; and a polyimide resin layer formed by applying a polyimide precursor resin convertible into a polyimide resin many times onto the metal clad, followed by drying, and by carrying out infrared ray (IR) heat treatment to convert the precursor resin into the polyimide resin. The polyimide resin layer that is in direct contact with the metal clad may have a glass transition temperature of 300° C. or higher. The polyimide resin layer may have an overall linear thermal expansion coefficient of 20 ppm/K or less.

It was found that when the polyimide precursor resin layer is converted into the polyimide resin through the IR heat treatment, it is possible to obtain a flexible metal clad laminate that shows a small dimensional change caused by heat treatment and causes no curling before and after etching, thereby solving the problems occurring in other commercially available products. It was also found that when a polyimide resin having a glass transition temperature of 300° C. or higher is used as a first dielectric layer that is in direct contact with the metal clad, it is possible to overcome the problem of deterioration in appearance during the conversion into polyimide. The present invention is based on these findings.

In this context, the polyimide resin is formed generally by applying a polyimide precursor resin onto a metal clad and thermally converting the precursor resin into the polyimide resin. However, the polyimide resin itself or semi-cured polyimide resin may be applied directly onto the metal clad.

As used herein, the term ‘metal clad’ includes conductive metals such as copper, aluminum, silver, palladium, nickel, chrome, molybdenum, tungsten, etc., and alloys thereof. In general, copper is used widely, but the scope of the present invention is not limited thereto. In addition, the metal clad may be subjected to physical or chemical surface treatment to increase the bonding strength between the metal layer and a dielectric layer coated thereon, and such treatment may include surface sanding, plating with nickel or copper-zinc alloy, coating with a silane coupling agent, or the like.

In some embodiments of the present invention, conductive metals such as copper, aluminum, silver, palladium, nickel, chrome, molybdenum, tungsten, etc., or alloys thereof may be used as the metal clad. Particularly, a copper metal clad is preferred because of its low cost and high conductivity. The metal clad may have a thickness of 5-40 μm for the purpose of precision circuit processing.

As used herein, the polyimide resin may be a resin having an imide ring represented by Chemical Formula 1, and may include polyimide, polyamideimide, polyesterimide, etc.:

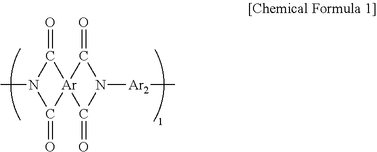

wherein

Ar and Ar₂ each represent an aromatic ring structure and independently represent (C6-C20)aryl, and I is an integer ranging from 1 to 10,000,000, wherein various structures may exist depending on the composition of the monomers used therein.

Particular examples of tetracarboxylic acid anhydrides used for preparing a polyimide resin to obtain the resin represented by Chemical Formula 1 include pyromellitic dianhydride, 3,3′,4,4′-biphenyltetracarboxylic acid dianhydride, 3,3′,4,4′-benzophenonetetracarboxylic acid dianhydride, etc. Such tetracarboxylic acid anhydrides are used generally for providing a low thermal expansion coefficient.

In addition, particularly useful examples of diamino compounds include 4,4′-diaminophenyl ether, p-phenylene diamine, 4,4′-thiobisbenzenamine, etc.

However, there is no particular limitation in the composition of the polyimide resin, as long as the polyimide resin has desired characteristics in view of the present invention. The polyimide resin may be used, in the form of homopolymers, derivatives thereof, or in the form of a blend of two or more of the homopolymers and derivatives thereof.

Further, other additives including chemical imidizing reagents such as pyridine, quinoline and the like, adhesion promoters such as silane coupling agent, titanate coupling agent, epoxy compound and the like, other additives such as defoamer for facilitating the coating process, or a leveling agent may be used.

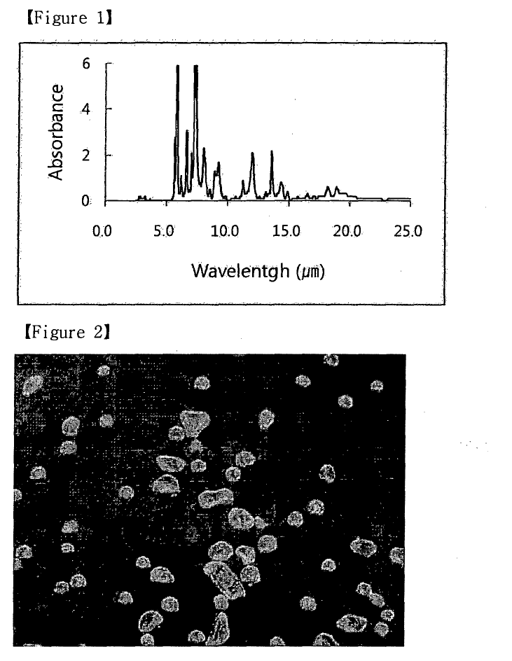

More particularly, the low-thermal expansion coefficient polyimide resin includes a polyimide resin represented by Chemical Formula 2. The polyimide resin represented by Chemical Formula 2 allows easy control of glass transition temperatures and linear thermal expansion coefficients. FIG. 1 is a IR absorption spectrometry of the polyimide resin according to the present invention. Referring to FIG. 1, the polyimide resin according to the present invention has a structure suitable for IR absorption in a wavelength range of 2-25 μm. Herein, the IR absorption spectrometry is carried out by mixing an analyte with potassium bromide (KBr) powder, pulverizing the mixture uniformly in a mortar, and forming a pellet from the mixture. To perform the IR spectrometry, a spectrometer of Magna 550 model available from Thermo Nicolet Co. is used.

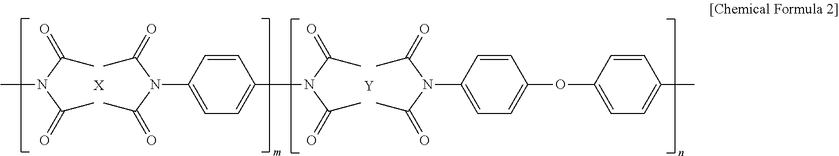

wherein

each of m and n is a real number satisfying the conditions of 0.6≦m≦1.0, 0≦n≦0.4 and m+n=1.

X and Y are independently selected from the following structures, which may be used alone or in a copolymerized form:

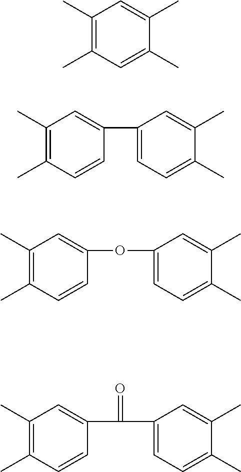

The polyimide resin that is in contact with the metal clad may have a glass transition temperature of 300° C. or higher, preferably 300-400° C. IR rays penetrate into a film to a large depth to allow uniform heat treatment inside the film, thereby increasing the heat treatment efficiency. However, there were problems in that rapid heating inside the film causes thermal decomposition of the polyimide precursor resin, resulting in deterioration of appearance, such as the blistering on a polyimide surface and delamination between polyimide resin layers or between polyimide resin layer and the metal clad, etc. As an attempt to solve such deterioration of appearance, a temperature increase may be delayed during the curing operation. However, this leads to a drop in productivity. Therefore, in order to solve the problem of deterioration of appearance during the manufacture process, it is required to use a heat-resistant polyimide resin having a glass transition temperature of 300° C. or higher as the polyimide layer that is in contact with the metal clad. When using a polyimide resin having a glass transition temperature lower than 300° C. as the resin that is in contact with the metal clad, the resultant laminate may have poor appearance after the heat treatment, as demonstrated by Comparative Example 3.

The dimensional stability of the metal clad laminate according to the present invention is related closely with the linear thermal expansion coefficient of the polyimide film. To obtain a laminate having high dimensional stability, it is preferred to use a polyimide resin having a low linear thermal expansion coefficient. The polyimide resin according to an embodiment of the present invention has a low linear thermal expansion coefficient of 20 ppm/K or lower, preferably 5-20 ppm/k. Due to such a low linear thermal expansion coefficient, it is possible to obtain a flexible metal clad laminate having a dimensional change of ±0.05% or less after heat treatment. Particularly, the flexible metal clad laminate according to an embodiment of the present invention preferably has a dimensional change of ±0.05% or less after subjecting it to heat treatment at 150° C. for 30 minutes on the basis of ‘Method C’ in IPC-TM-650, 2.2.4. More preferably, the flexible metal clad laminate has a dimensional change of −0.03 to +0.03% after such heat treatment.

In addition, according to another embodiment of the present invention, the polyimide layer present on the other surface of the polyimide layer that is in contact with the metal clad may have a linear thermal expansion coefficient of 20 ppm/K or lower. Further, the difference between the linear thermal expansion coefficient of the polyimide layer present on the other surface of the polyimide layer that is in contact with the metal clad and that of the polyimide layer that is in contact with the metal clad may be 5 ppm/K or less. Particularly, the linear thermal expansion coefficient of the polyimide layer present on the other surface of the polyimide layer that is in contact with the metal clad may be higher than that of the polyimide layer that is in contact with the metal clad by 0-5 ppm/k.

The polyimide resin layer may include a single layer having a linear thermal expansion coefficient of 20 ppm/K or less. However, a plurality of layers may be formed continuously through coating, drying and overall curing processes. In general, a plurality of layers having different linear thermal expansion coefficients is used to prevent curling before and after etching.

According to still another embodiment of the present invention, the polyimide film forming the laminate may have a tensile modulus of 4-7 GPa. When the tensile modulus is greater than 7 GPa, the polyimide film may have increased stiffness, resulting in degradation of flexural properties such as folding endurance. On the contrary, when the polyimide film forming the laminate has a tensile modulus less than 4 GPa, the polyimide film have poor stiffness, thereby causing a poor handling characteristics and a dimensional change during the processing of a printed circuit board. Particularly, such problems may occur frequently in the case of a thin laminate having a polyimide thickness of 20 μm or less. Therefore, the polyimide film forming the laminate suitably has a tensile modulus of 4-7 GPa.

The dielectric layer forming the laminate has a total thickness of 5-100 μm, and more generally 10-50 μm. The flexible metal clad laminate according to an embodiment of the present invention is useful for fabricating a flexible metal clad laminate having a thick polyimide layer with a thickness of 20 μm or higher.

According to still another embodiment of the present invention, the peel strength at the interface between the polyimide resin layer and the metal clad may be 0.5 kgf/cm or higher, preferably 0.5-3.0 kgf/cm to provide good adhesion between the polyimide resin layer and the metal clad as well as excellent appearance.

In addition, the present invention provides a method for manufacturing a flexible metal clad laminate, including applying a polyimide precursor resin convertible into a polyimide resin many times onto a metal clad, followed by drying, and further drying and curing the polyimide precursor resin with an IR heating system.

More particularly, the flexible metal clad laminate may be obtained by the method including: applying a polyamic acid solution having a glass transition temperature of 300° C. or higher after the final imidization onto one surface of a metal clad, and drying the solution at 80-180° C. to form a first polyimide layer; applying a polyamic acid solution having a linear thermal expansion coefficient of 20 ppm/K or less after the final imidization onto the first polyimide layer, and drying the solution at 80-180° C. to form a second polyimide layer and to obtain a laminate; and further drying and heat treating the laminate with an IR heating system at 80-400° C. to perform imidization.

According to an embodiment, after forming the laminate and before carrying out the IR heat treatment, a third polyimide layer may be further formed by applying a polyamic acid solution onto the second polyimide layer, followed by drying at 80-180° C., so that a plurality of polyimide layers may be formed.

Particularly, the heat treatment for converting the polyimide precursor resin into the polyimide resin may be carried out in a batch mode, wherein the polyimide precursor resin is applied and dried, and is allowed to stay in a hot furnace for a certain time, or a continuous mode, wherein the metal clad coated with the polyimide precursor resin is passed continuously through a hot furnace for a certain time. As the furnace, a hot air furnace is used generally under nitrogen atmosphere. However, the hot air furnace heats the resin layer from the surface thereof, and thus causes a difference in curing hysteresis along the thickness direction. As a result, such hot air furnaces are not suitable for uniform heat treatment, resulting in degradation of dimensional stability of a film, particularly when the film to be heat treated has a relatively large thickness. To solve this, the method according to an embodiment of the present invention utilizes an IR heating system. IR heating allows uniform heat treatment inside a film by virtue of deep penetration of IR into the film, and provides increased heat treatment efficiency. Therefore, even in the case of a thick film with a polyimide thickness of 20 μm or higher, it is possible to obtain a flexible metal clad laminate having excellent dimensional stability as demonstrated by a dimensional change of 0.03% or less after heat treatment.

The IR heating system used in the present invention emits light mainly in a wavelength range of 2-25 μm, and converts the polyimide precursor resin into the polyimide resin by subjecting the precursor resin to IR-heating under inert gas atmosphere. IR may be generated by any known methods, including IR filaments, IR-emitting ceramics, or the like, and there is no particular limitation in the methods. In addition, IR heating may be combined with supplementary hot air heating. Adequate IR treating conditions may be applied to obtain a laminate that causes no curling before and after etching, shows a small change in dimension after heat treatment, and has excellent appearance after completing imidization.

More particularly, the total heating time carried out at 80° C. or higher in the process of further drying and curing with an IR heating system after applying and drying the polyimide precursor resin may be 5-60 minutes and the heating may be carried out gradually from a low temperature to a high temperature. The highest heat treatment temperature is 300-400° C., preferably 350-400° C. When the highest heat treating temperature is lower than 300° C., sufficient imidization may not be accomplished, and thus it is difficult to obtain desired physical properties. When the highest heat treating temperature is higher than 400° C., the polyimide resin may be decomposed thermally.

In a temperature range of 80-180° C., the total time required for carrying out heat treatment at 80° C. or higher, including the drying and curing operation, may satisfy the condition represented by Formula 2. This range includes applying the polyimide precursor resin, drying the resin and initially curing the resin, and the heat treatment condition in this temperature range determines the linear thermal expansion coefficient of the final polyimide resin. When Formula 1 is greater than 2.0 in this temperature range, the resultant laminate causes curling with the polyimide layer oriented toward the inside after the completion of imidization as shown in Comparative Example 1. In addition, in this case, a dimensional change caused by heat treatment increases, and the resultant laminate may not have good appearance.

When Formula 1 is 1.0 or more, no curling occurs before and after etching, as evidenced by Examples 1 to 3. In addition, in this case, it is possible to realize a small dimensional change after heat treatment and to obtain a laminate having good appearance. Therefore, Formula 1 is preferably 1.0 or more. When Formula 1 is less than 1.0, the productivity may be degraded due to the undesirably delayed temperature increase.

$$\frac{t \times T}{{10}^{2}} \qquad [ Formula 1 ]$$

wherein

t is the thickness (μm) of the polyimide resin layer, and T is the average heating rate (K/min) in a temperature range of 80-180° C.

According to a particular embodiment of the present invention, there is provided a method for manufacturing a flexible metal clad laminate, wherein the total heating time carried out at 80° C. or higher in the process of further drying and curing with an IR heating system after applying and drying the polyimide precursor resin is 5-60 minutes, and the heat treating condition in a temperature range of 80-180° C. satisfies the condition represented by Formula 2:

$$1.0 \leq \frac{t \times T}{{10}^{2}} \leq 2.0 \qquad [ Formula 2 ]$$

wherein

t is the thickness (μm) of the polyimide resin layer, and T is the average heating rate (K/min) in a temperature range of 80-180° C.

In addition, the heat treating time carried out at a high temperature of 300° C. or higher in the process of further drying and curing with an IR heating system after applying and drying the polyimide precursor resin is suitably 10-40%, based on the total time required for carrying out heat treatment at 80° C. or higher, including the drying and curing operation. The heat treating time at 300° C. or higher affects the final degree of imidization of polyimide resin. When the ratio of the heat treating time at 300° C. or higher is less than 10%, sufficient curing may not be accomplished, resulting in degradation of the physical properties of the resultant polyimide film. On the other hand, when the ratio is greater than 40%, the productivity may be decreased due to the undesirably delayed curing time.

The flexible metal clad laminate according to the present invention may be produced in a batch mode, wherein the polyimide precursor resin is applied and dried, and is allowed to stay in a hot furnace for a certain time, or a continuous mode, wherein the metal clad coated with the polyimide precursor resin is passed continuously through a hot furnace for a certain time.

### Mode for Invention

The examples and experiments will now be described. The following examples and experiments are for illustrative purposes only and not intended to limit the scope of the present invention.

The following abbreviations are used.

DMAc: N,N-dimethylacetamide

BPDA: 3,3′,4,4′-biphenyltetracarboxylic acid dianhydride

PDA: p-phenylenediamine

ODA: 4,4′-diaminodiphenylether

BAPP: 2,2′-bis(4-aminophenoxyphenyl)propane

TPE-R: 1,3-bis(4-aminophenoxy)benzene

Physical properties are determined as follows.

(1) Linear Thermal Expansion Coefficient and Glass Transition Temperature

Linear thermal expansion coefficients are obtained based on thermomechanical analysis (TMA) by averaging the thermal expansion values at 100° C.-2501: from the thermal expansion values measured by heating a sample to 400° C. at a rate of 5° C./min. In addition, the inflection point in the thermal expansion curve obtained herein is defined as the glass transition temperature (Tg).

(2) Smoothness Before and after Etching

Laminates before and after etching are cut into a rectangle with a machine direction (MD) size of 20 cm and a transverse direction (TD) size of 30 cm. Then, the height of each edge is measured from the bottom. A height not greater than 1 cm is regarded as being smooth.

(3) Film Appearance after Imidization

The laminate surface is observed after imidization. The appearance of the laminate is regarded as being excellent, when no surface bubbling and swelling occur, and no delamination is observed between the layers of polyimide resin or at the interface between the polyimide resin and the metal clad.

(4) Dimensional Change

A dimensional change is determined after etching the metal clad and heat treating the laminate at 150° C. for 30 minutes according to ‘Method C’ defined in IPC-TM-650, 2.2.4.

(5) Tensile Modulus

Tensile modulus is measured by using a multi-purpose tester available from Instron Co., according to IPC-TM-650, 2.4.19.

### Preparation Example 1

First, 1,809 g of PDA and 591 g of ODA are dissolved completely with agitation into 25,983 g of DMAc solution under nitrogen atmosphere. Next, 6,000 g of BPDA as a dianhydride is added thereto in several portions. Then, the resultant mixture is agitated continuously for about 24 hours to provide a polyamic acid solution. The resultant polyamic acid solution so prepared is cast to prepare a film having a thickness of 20 μm and then the laminate is raised up to (heated to) 350° C. for 60 minutes and (is) maintained at 350° C. for 30 minutes to perform curing completely. It is shown that the laminate has a glass transition temperature and a linear thermal expansion coefficient of 314° C. and 9.9 ppm/K, respectively.

### Preparation Examples 2-7

Preparation Example 1 is repeated to provide laminates, except the compositions and amounts as described in Table 1 are used.

TABLE 1

| | | | | | CTE | Tg |
|---|---|---|---|---|---|---|
| | Dianhydride | Diamine 1 | Diamine 2 | DMAc | (ppm/K) | (° C.) |
| Prep. Ex. 1 | BPDA, | PDA, | ODA, | 25,983 g | 9.9 | 314 |
| | 6,000 g | 1,809 g | 591 g | | | |
| Prep. Ex. 2 | BPDA, | PDA, | ODA, | 32,419 g | 13.3 | 321 |
| | 5,700 g | 1,638 g | 758 g | | | |
| Prep. Ex. 3 | BPDA, | PDA, | ODA, | 16,989 g | 12.0 | 317 |
| | 3,000 g | 884 g | 359 g | | | |
| Prep. Ex. 4 | BPDA, | PDA, | BAPP, | 61,177 g | 24.2 | 343 |
| | 14,000 g | 4,496 g | 1,896 g | | | |
| Prep. Ex. 5 | BPDA, | PDA, | — | 22,688 g | 40 | 270 |
| | 1,500 g | 1,021 g | | | | |
| Prep. Ex. 6 | BPDA, | PDA, | ODA, | 33,108 g | 9.8 | 351 |
| | 7,000 g | 2,380 g | 591 g | | | |
| Prep. Ex. 7 | BPDA, | TPE-R, | — | 12,367 g | — | 232 |
| | 900 g | 894 g | | | | |

* CTE: coefficient of thermal expansion

### Example 1

The polyamic acid solution obtained from Preparation Example 1 is applied onto a copper foil with a thickness of 15 μm to a final thickness of 25 μm after curing, and subsequently dried at 150° C. to form a first polyimide precursor layer. Then, the polyamic acid solution obtained from Preparation Example 2 is applied onto one surface of the first polyimide precursor layer to a final thickness of 15 μm after curing, and subsequently dried at 150° C. to form a second polyimide precursor layer. The total heating time in applying the first polyimide layer and the second polyimide layer is 15.4 minutes.

The resultant laminate is heated with an infrared ray (IR) heating system from 150 to 395° C. to perform complete imidization. The results are shown in Table 2.

### Example 2

The polyamic acid solution obtained from Preparation Example 1 is applied onto a copper foil with a thickness of 15 μm to a final thickness of 10 μm after curing, and subsequently dried at 150° C. to form a first polyimide precursor layer. Then, the polyamic acid solution obtained from Preparation Example 1 is applied onto one surface of the first polyimide precursor layer to a final thickness of 12 μm after curing, and subsequently dried at 150° C. to form a second polyimide precursor layer. Then, the polyamic acid solution obtained from Preparation Example 2 is applied onto one surface of the second polyimide precursor layer to a final thickness of 13 μm after curing, and subsequently dried at 150° C. to form a third polyimide precursor layer. The total heating time in applying the first polyimide layer, the second polyimide layer and the third polyimide layer is 21.6 minutes. The resultant laminate is heated with an IR heating system from 150 to 395° C. to perform complete imidization. The results are shown in Table 2.

### Example 3

The polyamic acid solution obtained from Preparation Example 3 is applied onto a copper foil with a thickness of 12 μm to a final thickness of 15 μm after curing, and subsequently dried at 150° C. to form a first polyimide precursor layer. Then, the polyamic acid solution obtained from Preparation Example 3 is applied onto one surface of the first polyimide precursor layer to a final thickness of 10 μm after curing, and subsequently dried at 150° C. to form a second polyimide precursor layer. The total heating time in applying the first polyimide layer and the second polyimide layer is 10.7 minutes. The resultant laminate is heated with an IR heating system from 150 to 395° C. to perform complete imidization. The results are shown in Table 2.

### Comparative Example 1

The polyamic acid solution obtained from Preparation Example 1 is applied onto a copper foil with a thickness of 15 μm to a final thickness of 25 μm after curing, and subsequently dried at 150° C. to form a first polyimide precursor layer. Then, the polyamic acid solution obtained from Preparation Example 2 is applied onto one surface of the first polyimide precursor layer to a final thickness of 15 μm after curing, and subsequently dried at 150° C. to form a second polyimide precursor layer. The total heating time in applying the first polyimide layer and the second polyimide layer is 15.4 minutes. The resultant laminate is heated with an IR heating system from 150 to 395° C. to perform complete imidization. The results are shown in Table 2.

### Comparative Example 2

The polyamic acid solution obtained from Preparation Example 4 is applied onto a copper foil with a thickness of 15 μm to a final thickness of 25 μm after curing, and subsequently dried at 140° C. to form a first polyimide precursor layer. Then, the polyamic acid solution obtained from Preparation Example 2 is applied onto one surface of the first polyimide precursor layer to a final thickness of 15 μm after curing, and subsequently dried at 140° C. to form a second polyimide precursor layer. The total heating time in applying the first polyimide layer and the second polyimide layer is 11.5 minutes. The resultant laminate is heated with an IR heating system from 150 to 390° C. to perform complete imidization. The results are shown in Table 2.

### Comparative Example 3

The polyamic acid solution obtained from Preparation Example 5 is applied onto a copper foil with a thickness of 12 μm to a final thickness of 2.5 μm after curing, and subsequently dried at 150° C. to form a first polyimide precursor layer. Then, the polyamic acid solution obtained from Preparation Example 6 is applied onto one surface of the first polyimide precursor layer to a final thickness of 20 an after curing, and subsequently dried at 150° C. to form a second polyimide precursor layer. Then, the polyamic acid solution obtained from Preparation Example 7 is applied onto one surface of the second polyimide precursor layer to a final thickness of 3 μm after curing, and subsequently dried at 150° C. to form a third polyimide precursor layer. The total heating time in applying the first polyimide layer, the second polyimide layer and the third polyimide layer is 15.3 minutes. The resultant laminate is heated with an IR heating system from 150 to 395° C. to perform complete imidization. The results are shown in Table 2.

TABLE 2

| | | | | Comp. | Comp. | Comp. |
|---|---|---|---|---|---|---|
| | Ex. 1 | Ex. 2 | Ex. 3 | Ex. 1 | Ex. 2 | Ex. 3 |
| Tg of the layer that is in | 314 | 314 | 317 | 314 | 343 | 270 |
| contact with metal (° C.) | | | | | | |
| Linear thermal expansion | 18.5 | 16.5 | 17.7 | 19.1 | 21.8 | — |
| coefficient of polyimide | | | | | | |
| film after imidization | | | | | | |
| (ppm/K) | | | | | | |
| Total heating time at 80° C. | 30.8 | 37.2 | 18.4 | 30.9 | 26.9 | 26.8 |
| or higher (min.) | | | | | | |
| Highest curing | 395 | 395 | 395 | 395 | 390 | 395 |
| temperature (° C.) | | | | | | |
| 80° C. ≦ treating | 1.80 | 1.26 | 1.95 | 2.20 | 2.92 | 1.48 |
| temperature ≦ 180° C. | | | | | | |
| Heat treating time at | 5.3 | 6.4 | 4.3 | 11.2 | 9.4 | 10.4 |
| 300° C. or higher (min.) | | | | | | |
| Curling before and after | no | no | no | Curling | Curling | — |
| etching | | | | toward | toward | |
| | | | | inside (resin | inside (resin | |
| | | | | side before | side before | |
| | | | | etching) | etching) | |
| Appearance after | good | good | good | good | good | Poor |
| imidization | | | | | | (FIG. 2) |
| Tensile modulus (MD/TD, | 5.5/5.4 | 6.6/6.5 | 5.5/5.3 | — | — | — |
| GPa) | | | | | | |
| Dimensional Change | −0.02/−0.02 | −0.01/0.00 | 0.01/0.01 | −0.05/−0.05 | −0.09/−0.10 | — |
| (MD/TD, %) | | | | | | |

* t: thickness (μm) of the polyimide resin layer
* T: average heating rate (K/min) in a temperature range of 80-180° C.

FIG. 2 is a photographic view showing the surface appearance of the flexible metal clad laminate according to Comparative Example 3. As can be seen from FIG. 2, the use of a resin having a glass transition temperature of 270° C. (temperature lower than 300° C.) in the first polyimide layer causes bubble generation on the surface of the metal clad, resulting in poor appearance.

The present application contains subject matter related to Korean Patent Application No. 10-2009-0045654, filed in the Korean Intellectual Property Office on May 25, 2009, the entire contents of which is incorporated herein by reference.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

1. A flexible metal clad laminate, comprising:
a metal clad; and
a polyimide resin layer formed by applying a polyimide precursor resin convertible into a polyimide resin many times onto the metal clad, followed by drying, and by further drying and curing the polyimide precursor resin with an infrared ray (IR) heating system.

2. The flexible metal clad laminate according to claim 1, wherein the polyimide resin layer has an overall linear thermal expansion coefficient of 20 ppm/K or lower.

3. The flexible metal clad laminate according to claim 1, wherein the polyimide resin layer that is in direct contact with the metal clad has a glass transition temperature of 300° C. or higher.

4. The flexible metal clad laminate according to claim 1, wherein the polyimide resin layer that is in direct contact with the metal clad has a composition represented by Chemical Formula 2: 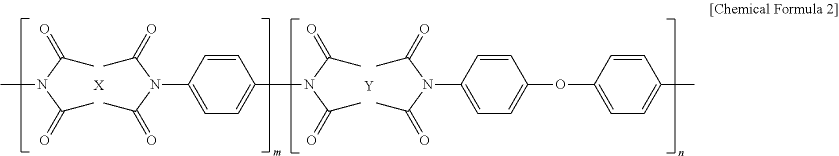
wherein
each of m and n is a real number satisfying the conditions of 0.6≦m≦1.0, 0≦n≦0.4 and m+n=1; and
X and Y are independently selected from the following structures, which may be used alone or in a copolymerized form:

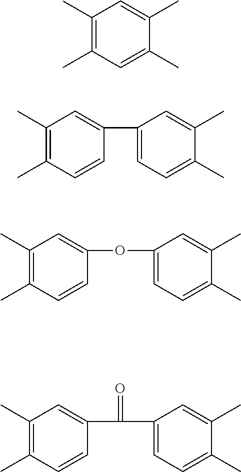

5. The flexible metal clad laminate according to claim 1, which has a dimensional change of ±0.05% or less after subjecting it to heat treatment at 150° C. for 30 minutes on the basis of ‘Method C’ in IPC-TM-650, 2.2.4.

6. The flexible metal clad laminate according to claim 1, wherein the tensile modulus of total polyimide resin layers is in the rage of 4˜7 Gpa.

7. The flexible metal clad laminate according to claim 1, wherein the peel strength at the interface between the polyimide resin layer and the metal clad is 0.5 kgf/cm or higher.

8. The flexible metal clad laminate according to claim 1, wherein the polyimide layer present on the other surface of the polyimide layer that is in contact with the metal clad has a linear thermal expansion coefficient of 20 ppm/K or lower, and the difference between the linear thermal expansion coefficient of the polyimide layer present on the other surface of the polyimide layer that is in contact with the metal clad and that of the polyimide layer that is in contact with the metal clad is 5 ppm/K or less.

9. A method for manufacturing a flexible metal clad laminate, comprising:
applying a polyimide precursor resin convertible into a polyimide resin many times onto a metal clad, followed by drying; and
further drying and curing the polyimide precursor resin with an infrared ray (IR) heating system.

10. The method for manufacturing a flexible metal clad laminate according to claim 9, which comprises:
applying a polyamic acid solution having a glass transition temperature of 300° C. or higher after the final imidization onto one surface of a metal clad, and drying the solution at 80-180° C. to form a first polyimide layer;
applying a polyamic acid solution having a linear thermal expansion coefficient of 20 ppm/K or less after the final imidization onto the first polyimide layer, and drying the solution at 80-180° C. to form a second polyimide layer and to obtain a laminate; and
further drying and heat treating the laminate with an infrared ray (IR) heating system at 80-400° C. to perform imidization.

11. The method for manufacturing a flexible metal clad laminate according to claim 10, which further comprises, between said forming of the second polyimide layer and said drying and heat treating, applying a polyamic acid solution onto the second polyimide layer, and drying the solution at 80-180° C. to form a third polyimide layer.

12. The method for manufacturing a flexible metal clad laminate according to claim 9, wherein the total heating time carried out at 80° C. or higher during applying and drying the polyimide precursor resin and further drying and curing with an infrared ray heating system is 5-60 minutes, and the heat treating condition in a temperature range of 80-180° C. satisfies the condition represented by Formula 2:
$$1.0 \leq \frac{t \times T}{{10}^{2}} \leq 2.0 \qquad [ Formula 2 ]$$
wherein
t is the thickness (μm) of the polyimide resin layer, and T is the average heating rate (K/min) in a temperature range of 80-180° C.

13. The method for manufacturing a flexible metal clad laminate according to claim 12, wherein the total heating time carried out at 300° C. or higher in said drying and curing with an infrared ray (IR) heating system after applying and drying the polyimide precursor resin is 10-40% based on the total heat treating time over 80° C.

14. The method for manufacturing a flexible metal clad laminate according to claim 9, which is carried out in a batch mode, wherein the polyimide precursor resin is applied and dried, and is allowed to stay in a hot furnace for a certain time, or a continuous mode, wherein the metal clad coated with the polyimide precursor resin is passed continuously through a hot furnace for a certain time.
